(19) United States
(12) Patent Application Publication
(10) Pub. No.: US 2017/0185605 A1
(43) Pub. Date: Jun. 29, 2017

(54) FILE SERVER APPARATUS, METHOD, AND COMPUTER SYSTEM

(71) Applicant: Hitachi, Ltd., Tokyo (JP)

(72) Inventors: Takuya HIGUCHI, Tokyo (JP); Hitoshi ARAI, Tokyo (JP); Sadahiro NAKAMURA, Tokyo (JP); Nobuyuki SAIKA, Tokyo (JP)

(21) Appl. No.: 15/301,420

(22) PCT Filed: Sep. 10, 2014
(86) PCT No.: PCT/JP2014/073893

§ 371 Date: Oct. 3, 2016

(51) Int. Cl. G06F 17/30; G06F 3/06

(52) U.S. Cl. CPC G06F 17/30073; G06F 17/30091; G06F 3/0604; G06F 3/0659; G06F 3/0683

(57) ABSTRACT

A file server apparatus includes a memory which stores a program for controlling storage of data of a file in a storage apparatus, and a processor which executes the program. The processor manages a capacity of a storage area of an archive system in which a file stored in the storage apparatus is archived and manages a used capacity of the storage area. When receiving a write request of a file, the processor calculates a used capacity of the storage area of the archive system where a file related to the write request is archived and determines whether or not the file related to the write request can be archived in the archive system based on the capacity of the storage area of the archive system and the calculated used capacity. When determining that archiving cannot be performed, the processor notifies the host computer of an error.

### TECHNICAL FIELD

The present invention relates to a file server apparatus.

### BACKGROUND ART

A file storage system is known which manages a capacity of a storage area of a file supplied to each user and, when a user attempts to store data exceeding the capacity, returns an error to the user (PTL 1).

In addition, a computer system is known which archives data written in a file storage system to an archive storage system coupled to the file storage system (PTL 2).

### CITATION LIST

### Patent Literature

[PTL 1]

US Patent Application Publication No. 2005/0044198

[PTL 2]

US Patent Application Publication No. 2012/0066179

### SUMMARY OF INVENTION

### Technical Problem

In PTL 1, a file storage system manages a capacity of a file stored in the file storage system for each user.

In PTL 2, a file storage system configures a capacity restriction on storable data for each user and determines whether or not data of a user can be written based on the capacity restriction of the file storage system.

However, there may be cases where capacities of a storage area usable by a user differ between a file storage system and an archive storage system. Therefore, when a file storage system stores data based on its own capacity restriction, a capacity restriction of an archive system may be exceeded and archive files may no longer be stored.

### Solution to Problem

In order to solve the problem described above, a file server apparatus according to the present invention is coupled to a host computer, a storage apparatus storing data of a file, and an archive system in which a file stored in the storage apparatus is archived, and includes a memory which stores a program for controlling storage of data of a file in the storage apparatus, and a processor which executes the program. The processor manages a capacity of a storage area of the archive system and a used capacity of the storage area. When receiving a write request of a file from the host computer, the processor calculates a used capacity of the storage area of the archive system in a case where a file related to the write request is archived and determines whether or not the file related to the write request can be archived in the archive system based on the capacity of the storage area of the archive system and the calculated used capacity. When determining that archiving cannot be performed, the processor notifies the host computer of an error.

### Advantageous Effects of Invention

According to the present invention, an archive file can be appropriately stored in an archive system.

### BRIEF DESCRIPTION OF DRAWINGS

FIG. 1 shows a hardware configuration of a computer system according to a present embodiment.

FIG. 2 shows a software configuration of a computer system according to the present embodiment.

FIG. 3 shows an example of a subtree information management table 300.

FIG. 4 shows an example of a usage estimation table 400.

FIG. 5 shows an example of linkage information 500.

FIG. 6 shows an example of an inode management table.

FIG. 7 shows a flow chart of a linking process.

FIG. 8 shows a first half of a flow chart of a reception process of a read or write request of a file.

FIG. 9 shows a second half of a flow chart of a reception process of a read or write request of a file.

FIG. 10 shows a flow chart of a capacity estimation process when a creation request and a write request of a file are made.

FIG. 11 shows a flow chart of a reception process of a deletion request of a file.

FIG. 12 shows a flow chart of a capacity estimation process when a deletion request of a file is made.

FIG. 13 shows a first half of a flow chart of a data mover process.

FIG. 14 shows a second half of a flow chart of a data mover process.

FIG. 15 is a flow chart of an error correction process.

FIG. 16 shows a flow chart of a reception process of a creation request of a file.

FIG. 17 shows an example of an indication screen of an NS linking process.

### DESCRIPTION OF EMBODIMENT

Hereinafter, an embodiment of the present invention will be described with reference to the drawings. In the following drawings, a same portion will be denoted by a same reference sign. However, the present invention is not limited to the present embodiment and all modifications conforming to the spirit of the present invention are to be included in the technical scope of the present invention. In addition, unless particular limitations apply, each component may be provided in plurality or provided singularly.

Moreover, although various types of information will be described below using expressions such as an “xxx table”, the various types of information may be expressed by data structures other than a table. An “xxx table” can also be referred to as “xxx information” in order to demonstrate that information is not dependent on data structure.

In addition, while a “program” is sometimes used as a subject when describing a process in the following description, since a program causes a prescribed process to be performed by appropriately using a storage resource (such as a memory) and a communication interface apparatus (such as a communication port) when being executed by a processor (such as a CPU (central processing unit)), a “processor” may be used instead as a subject of a process. The processor may include dedicated hardware other than a CPU. A computer program may be installed to each computer from a program source. The program source may be replaced by, for example, a program distribution server or a storage medium.

Furthermore, although each element can be identified by identification information such as an ID, a number, and an identifier, various other types of information such as a name may be used instead as long as the information enables identification. Moreover, in the following description, identification information such as an ID, an identifier, and a number may sometimes be used as information for identifying some kind or target in place of the reference signs used in the drawings.

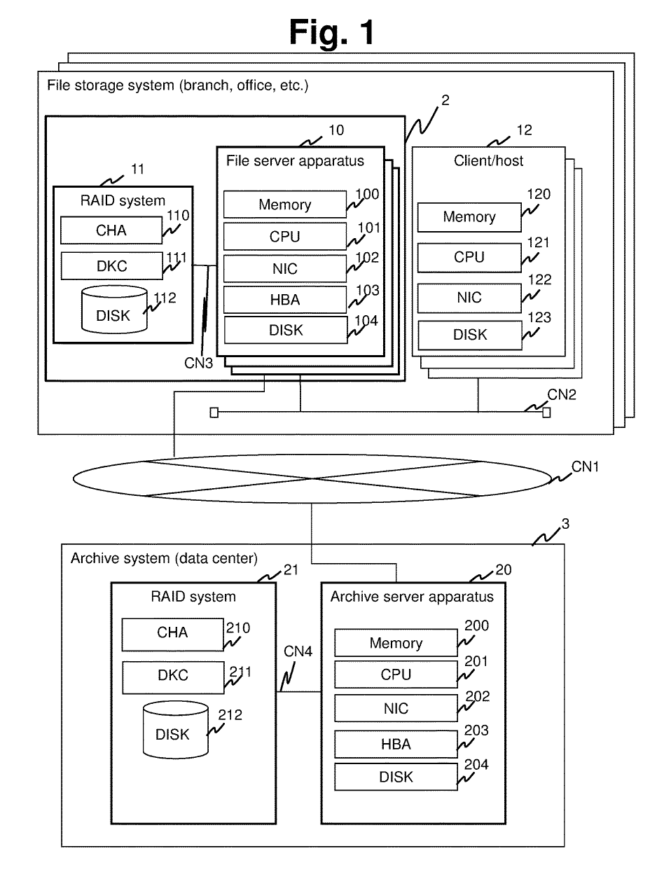

FIG. 1 shows a hardware configuration of a computer system according to a present embodiment.

A computer system includes a file storage system 2 and an archive system 3. The file storage system 2 is, for example, a base of operations where a user conducts business such as a branch or a sales office. In addition, the archive system 3 is, for example, a data center and includes at least one storage apparatus.

Moreover, while the file storage system 2 is provided in plurality and the archive system 3 is provided singularly in FIG. 1, the file storage system 2 and the archive system 3 may be provided in any number. In addition, while FIG. 1 shows a plurality of file server apparatuses 10 and a plurality of clients/hosts (hereinafter, abbreviated as hosts) 12 as the file storage system 2, the file server apparatuses 10 and the hosts 12 may also be provided in any number.

The file storage system 2 includes a RAID system 11 and a file server apparatus 10. In addition, the file storage system 2 may be coupled to the host 12 or may include the host 12. The file server apparatus 10 is coupled to the host 12 via, for example, a communication network CN2 that is a LAN (local area network) or the like. Furthermore, the file server apparatus 10 is coupled to the RAID system 11 via, for example, a communication network CN3 that is a SAN (storage area network) or the like.

The RAID system 11 is a storage apparatus and includes a CHA (channel adaptor) 110, a DKC (disk controller) 111, and a DISK 112. The CHA 110 and the DISK 112 are coupled to the DKC 111. The CHA 110 is a communication interface apparatus to be coupled to the file server apparatus 10. The DKC 111 is a controller. The DISK 112 is a disk-type physical storage device (for example, an HDD (hard disk drive)). The physical storage device may be a physical storage device of another type (for example, a flash memory device). In addition, while FIG. 1 shows a single DISK 112, the DISK 112 may be provided in plurality. One or more RAID (redundant arrays of inexpensive disks) groups may be constructed by a plurality of the DISKs 112.

The RAID system 11 receives a block-level I/O (input or output) request transmitted from the file server apparatus 10 with the CHA 110 and, based on control of the DKC 111, executes I/O to an appropriate DISK 112.

The file server apparatus 10 includes a memory 100, a processor (CPU) 101, an NIC (network interface card) 102, an HBA (host bus adaptor) 103, and a DISK 104. The CPU 101 is coupled to the memory 100, the NIC 102, and the HBA 103.

The NIC 102 is an interface for communicating with an archive server apparatus 20 and the host 12.

The HBA 103 is an interface for communicating with the RAID system 11.

The memory 100 is a storage area (for example, a RAM (random access memory) or a ROM (read only memory)) which the CPU 101 can directly write to or read from. The file server apparatus 10 reads a program (for example, an OS (operating system)) for controlling the file server apparatus 10 to the memory 100 and causes the CPU 101 to execute the program. While the program is stored in the DISK 112 of the RAID system 11, the program may alternatively be stored in the DISK 114 or stored in the memory 100 in advance. In addition, the file server apparatus 10 may include other types of storage resources in place of, or in addition to, the memory 100 and the DISK 104.

The file server apparatus 10 receives a process request of a file from the host 12 via the NIC 102. Examples of a process request of a file include a read request, a write request (update request), a creation request, a deletion request, and a metadata change request. The file server apparatus 10 creates a block-level I/O request for I/O of a data block which constitutes a file specified by the process request. The file server apparatus 10 transmits the block-level I/O request to the RAID system 11 via the HBA 103.

The host 12 includes a memory 120, a CPU 121, an NIC 122, and a DISK 123. The host 12 may include other types of storage resources in place of, or in addition to, the memory 120 and the DISK 123.

The host 12 reads a program (for example, an OS) for controlling the host 12 to the memory 120 and causes the CPU 121 to execute the program. The program may be stored in the DISK 123 or may be stored in the memory 120 in advance. In addition, the host 12 transmits a process request of a file to the file server apparatus 10 via the NIC 122.

The archive system 3 includes a RAID system 21 and the archive server apparatus 20. The RAID system 21 is coupled to the archive server apparatus 20.

The RAID system 21 is a storage apparatus and includes a CHA 210, a DKC 211, and a DISK 212. In FIG. 1, a configuration of the RAID system 21 and a configuration of the RAID system 11 are the same. Therefore, the RAID system 21 also receives a block-level I/O request transmitted from the archive server apparatus 20 with the CHA 210 and, based on control of the DKC 211, executes I/O to an appropriate DISK 212. Moreover, the configuration of the RAID system 21 and the configuration of the RAID system 11 may differ from each other.

The archive server apparatus 20 includes a memory 200, a processor (CPU) 201, an NIC 202, an HBA 203, and a DISK 204. The archive server apparatus 20 reads a program (for example, an OS) for controlling the archive server apparatus 20 to the memory 200 and causes the CPU 201 to execute the program. While the program is stored in the DISK 212 of the RAID system 21, the program may alternatively be stored in the DISK 204 or stored in the memory 200 in advance. In addition, the archive server apparatus 20 may include other types of storage resources in place of, or in addition to, the memory 200 and the DISK 204. Furthermore, the archive server apparatus 20 communicates with the file server apparatus 10 via the NIC 202 and a communication network CN4. The archive server apparatus 20 is coupled via the HBA 203 and performs accesses in block units.

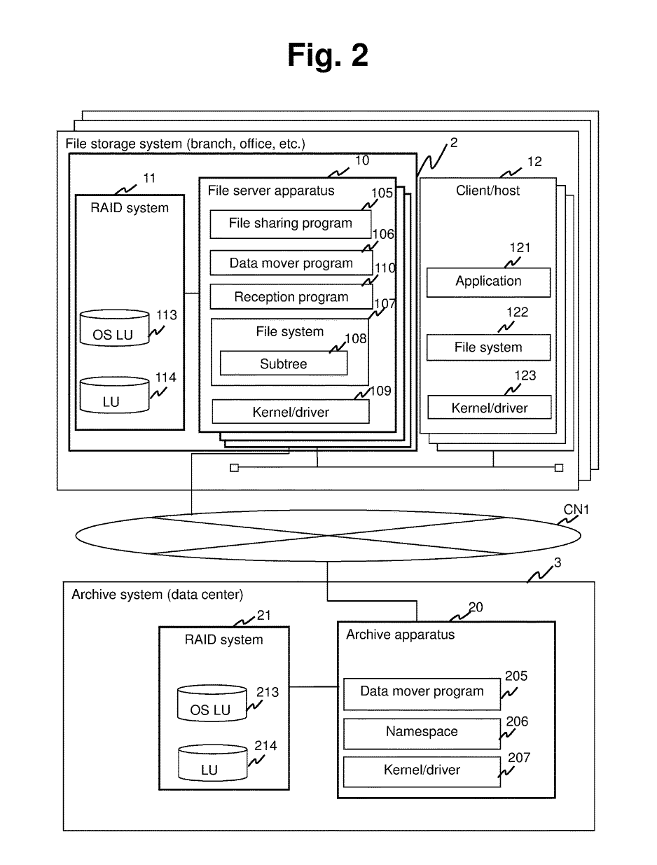

FIG. 2 shows a software configuration of a computer system according to example 1.

The RAID system 11 (21) includes an OS LU 113 (213) and an LU (logical unit) 114 (214). The OS LU 113 (213) and the LU 114 (214) are logical storage devices. The OS LU 113 (213) and the LU 114 (214) may respectively be substantial LUs based on one or more DISKs 112 (212) or may be virtual LUs in accordance with thin provisioning. The OS LU 113 (213) and the LU 114 (214) are respectively constituted by a plurality of blocks (storage areas). The OS LU 113 (213) may store a program (an OS) which controls each server apparatus 10 (20). The LU 114 (214) stores files. In addition, the LU 114 (214) may store all of or a part of file management information to be described later.

The memory 100 of the file server apparatus 10 stores a file sharing program 105, a data mover program 106, a reception program 110, a file system program 107, and a kernel/driver 109. The file system program 107 includes subtree management information 108.

The file sharing program 105 is a program which provides a file sharing service with the host 12 using a communication protocol such as CIFS (Common Internet File System) or NFS (Network File System). The reception program 110 is a program which performs various file operations based on a process request of a file from the host 12. The kernel/driver 109 performs overall control and hardware-specific control such as schedule control of a plurality of programs (processes) running on the file server apparatus 10 and handling of interrupts from hardware. The data mover program 106 will be described later.

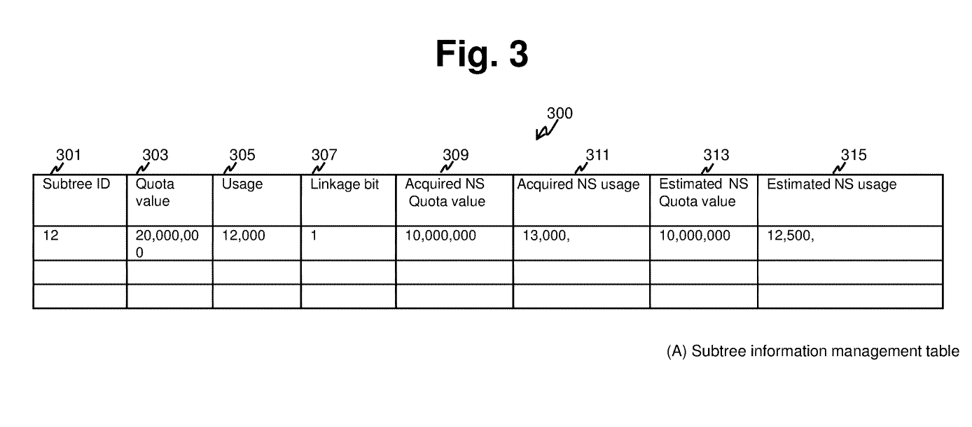

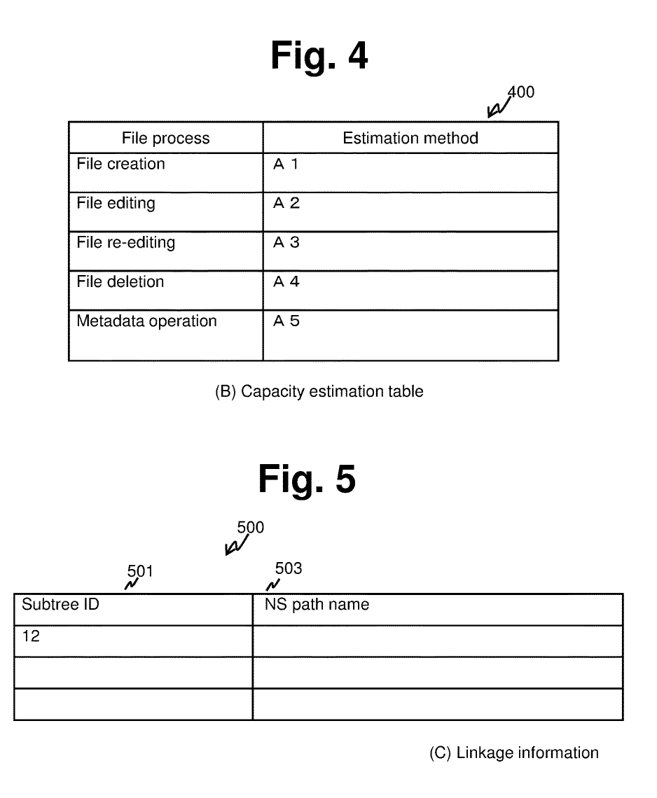

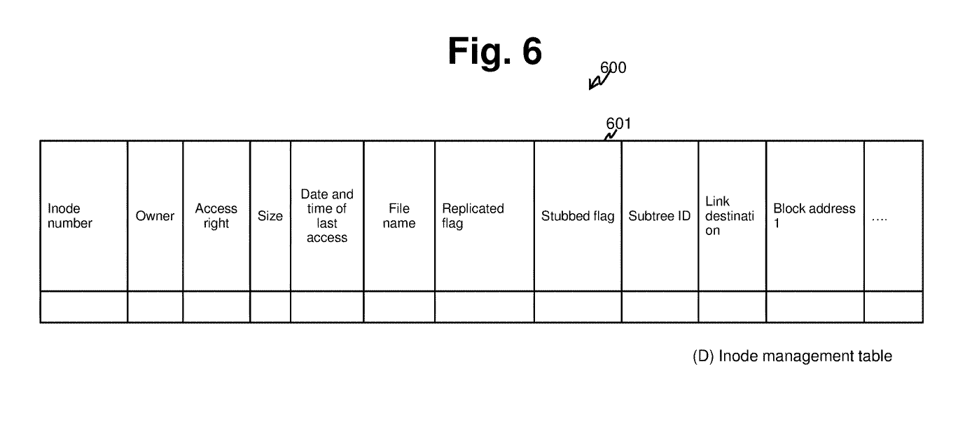

The file system program 107 is a program for realizing a file system. The file system program 107 includes subtree management information 108 (in the drawing, subtree) for managing a subtree. The subtree management information 108 includes management information (file management information) of a file belonging to a subtree. The subtree management information 108 may be, for example, an inode management table 600 to be described later (FIG. 6). In addition, for example, the subtree management information 108 may include a subtree information Management table 300 (FIG. 3), a usage estimation table 400 (FIG. 4), and linkage information 500 (FIG. 5). Moreover, in the present embodiment, a subtree is assumed to be a group of objects (files and directories) which constitute a part of a tree in a file system and a unit in which files written by one user are to be managed. However, a unit of a subtree is not limited thereto and may be a unit in which files written by a plurality of users (a user group) are to be managed or a unit in which files written by one or a plurality of hosts 12 are to be managed.

The memory 200 of the archive server apparatus 20 stores a data mover program 205, a namespace program 206, and a kernel/driver 207. The kernel/driver 207 is approximately similar to the kernel driver 109 described earlier.

The namespace program 206 is a program for realizing a namespace. In the present embodiment, a namespace is a namespace created on the archive system 3 and one subtree of the file system is associated with one namespace. For example, a file written by one user is managed by one subtree and written to the LU 114 and, at the same time, archived as an archive file in the LU 214 by being replicated to or synchronized with one namespace corresponding to the subtree. In the following description and in the drawings, a namespace may sometimes be abbreviated as NS. The namespace program 206 includes archive file management information which is file management information of an archive file stored in a namespace. Moreover, the file system in the archive server apparatus 20 may differ from the file system in the file server apparatus 10. In addition, archive file management information is information that differs from the file management information described earlier and a size of the information also differs. For example, while archive file management information may include a table for managing an inode of each archive file (a table corresponding to an inode management table), metadata included in the table differs. For example, the table may include information of a case where archive files are compressed or deduplicated or information of a case where archive files are under generation management.

The data mover program 106 of the file server apparatus 10 and the data mover program 205 of the archive server apparatus 20 will now be described. Hereinafter, the data mover program 106 in the file server apparatus 10 will be referred to as a “local mover”, the data mover program 205 in the archive server apparatus 20 will be referred to as a “remote mover”, and the term “data mover program” will be used when no particular distinction is made between the data mover programs 106 and 205. Files are exchanged between the file server apparatus 10 and the archive server apparatus 20 via the local mover 106 and the remote mover 205.

The local mover 106 writes a file to the LU 114 of the RAID system 11 and, at the same time, transfers a replication target file written to the LU 114 to the archive server apparatus 20. The remote mover 205 receives the replication target file from the file server apparatus 10 and writes an archive file of the file to the LU 214 of the RAID system 21. Due to the series of processes, a copy of the file stored in the file storage system 2 is created in the archive system 3. The series of processes is referred to as replicating a replication target file. In addition, creating a copy of a file stored in the file storage system 2 in the archive system 3 is also referred to as archiving.

In addition, the local mover 106 acquires a target file updated after replication from the LU 114 of the RAID system 11 and transfers the updated target file to the archive server apparatus 20. The remote mover 205 receives the updated target file from the file server apparatus 10 and overwrites an archive file stored in the LU 214 with an archive file of the received file. The series of processes is referred to as synchronizing a target file with an archive file.

Moreover, the local mover 106 may replicate the updated target file. For example, in this case, the replication target file is said to be under generation management. When generation management is performed, an archive file of the target file may include files created in the archive system 3 by a plurality of replications of the target file.

In addition, when prescribed conditions are satisfied, the local mover 106 deletes an entity (data) of the replicated file in the LU 114. This is, for example, a substantial migration of the replicated file. Hereinafter, this process will be referred to as stubbing a file. Subsequently, when a read request is received from the host 12 with respect to the stub, the local mover 106 acquires a file linked to the stub via the remote mover 205 and transmits the acquired file to the host 12. Moreover, in the present embodiment, a stub refers to an object (metadata) associated with storage destination (link destination) information of a file. The host 12 is unable to distinguish a file from a stub.

The memory 120 of the host 12 stores an application 121, a file system program 131, and a kernel/driver 123.

The application 121 is software (application program) used by the host 12 in accordance with a purpose of an operation. The file system program 131 and the kernel/driver 123 are similar to the file system program 107 and the kernel/driver 109 (207) described earlier.

FIG. 6 shows an example of an inode management table.

The inode management table 600 is constituted by a plurality of inodes. One entry corresponds to one inode, and one inode corresponds to one file. Each inode is constituted by a plurality of pieces of metadata. Types of metadata include an inode number of the file, an owner of the file, access rights to the file, a file size, a date and time of last access to the file, a file name, a replicated flag, a stubbed flag, a link destination of the file, and a position (block address ) in the LU 114 where an entity of the file is stored. The replicated flag indicates whether or not an archive file in the archive system 3 is in a state of synchronization (a synchronized state) with the file. In other words, in this state, consistency of data is achieved between the file in the file storage system 2 and the archive file in the archive system 3. In a state where the file is not updated after being replicated or synchronized, the replicated flag is switched “ON”, and in a state where the file is not replicated or synchronized after being created or updated, the replicated flag is switched “OFF”. The stubbed flag is “ON” when the file has been stubbed and is “OFF” when the file has not been stubbed. The link destination is an inode number of a file to which the stub is linked. In addition, the file is stubbed in a synchronized state with the archive file. Therefore, in a state where the file is stubbed or, in other words, when the stubbed flag is “ON”, the replication flag of the file is “ON”.

In addition, in the present embodiment, each inode includes a subtree ID 601. The subtree ID 501 is an identifier of a subtree in which the file is stored.

FIG. 3 shows an example of the subtree information management table 300.

The subtree information management table 300 is stored in a memory of each file server apparatus 10. The table 300 is a table which manages information related to a subtree of a file system included in the file server apparatus 10. For example, the table 300 manages a capacity of a storage area (NS) of an archive system corresponding to a subtree and a used capacity of the storage area (NS). The table 300 has an entry for each subtree. A subtree ID 301 is an identifier of the subtree. A Quota value 303 indicates a restricted capacity of the LU 114 which can be used by the subtree. Therefore, for example, when one user uses one subtree, the Quota value 303 is a restricted capacity (capacity) of the LU 114 which can be used by one user. Usage 305 indicates an amount (capacity) of the LU 114 which is actually being used by the subtree. A linkage bit (A1) 307 is a bit indicating whether or not the file storage system 2 is linked with the archive system 3. As used herein, linkage refers to a state where, for example, a subtree of the file storage system 2 is associated with an NS of the archive system 3 and the NS is capable of managing an archive file of a file being managed by the subtree. When the linkage bit is “1”, the file storage system 2 and the archive system 3 are linked, but when the linkage bit is “0”, the file storage system 2 and the archive system 3 are not linked. When the file storage system 2 and the archive system 3 are linked, a Quota value (capacity of a storage area) of a subtree and a Quota value (capacity of a storage area) of an NS corresponding to the subtree are the same, and values are set to items of an acquired NS Quota value 309, acquired NS usage 311, an estimated NS Quota value 313, and estimated NS usage 315.

The acquired NS Quota value 309 indicates a restricted capacity of the LU 214 which can be used by an NS corresponding to the subtree. Therefore, for example, when one user uses one subtree, the acquired NS Quota value 309 is a restricted capacity of the LU 214 which can be used by one user. The acquired NS usage 311 indicates an amount of the LU 214 which is actually being used by the NS corresponding to the subtree. The estimated NS Quota value 313 indicates an estimated value of a restricted capacity of the LU 214 which can be used by the NS corresponding to the subtree. The estimated NS usage 315 indicates an estimated value of an amount of the LU 214 actually being used by the NS corresponding to the subtree. Moreover, while the Quota value 202 and the acquired NS Quota value 309 are set in advance based on a contract with a user in the present embodiment, this is not restrictive. In addition, the estimated NS Quota value 313 may be the same as the acquired NS Quota value 309. The acquired NS usage 311 is a value which is measured and stored by the archive server apparatus 20 and which is acquired from the archive server apparatus 20 during replication or synchronization. Furthermore, the estimated NS usage 315 is a value estimated by the file server apparatus 10. In a synchronized state, the estimated NS usage 315 is equal to the acquired NS usage 311.

A specific description will be given below. First, as a premise, a case where a file operation is performed on a file A belonging to a subtree will be considered. Let us assume that usage of the subtree after the file operation on the file A has been performed is B (usage 305), which can be broken down to a sum B10 of actual data amounts of all files stored in the subtree and an amount B20 of file management information of all files stored in the subtree. In addition, let us assume that a value estimated by the file server apparatus 10 as usage of an NS corresponding to the subtree in a case where all files stored in the subtree are archived to the NS is C, which can be broken down to a value C10 estimated by the file server apparatus 10 as a sum of actual data amounts of all archive files stored in the NS and a value C20 estimated by the file server apparatus 10 as an amount of archive file management information of all archive files managed by the NS. Furthermore, a capacity of a difference of C with respect to B is assumed to be α. The file server apparatus 10 may calculate a based on a difference in management information between the file server apparatus 10 and the archive server apparatus 20 or may calculate a based on usage of NS as acquired from the archive server apparatus 20.

In this case, the estimated NS usage 315 may be a value obtained by adding a to B. In addition, the estimated NS usage 315 may be a value obtained by adding C20 to B10. Moreover, α may be a sum (α=α1+α2 . . . αn) of differences between an amount of increase/decrease of the usage B of the subtree and an amount of increase/decrease of the usage C of the NS with respect to file operations of all files (f1, f2 . . . fn) stored in the subtree. When actual data amounts of files and archive files thereof are the same, by estimating the estimated NS usage 315 by separating actual data from file management information (archive management information), an error between a case where files are stored in the file server apparatus 10 and a case where files are stored in the archive server apparatus 20 can be reduced.

In addition, the estimated NS usage 315 may be calculated by the CPU 101 of the file server apparatus 10 based on the usage estimation table 400 shown in FIG. 4 when, for example, a process request of a file is issued from the host 12. For example, when a file process request is received from a host computer, each file server apparatus 10 calculates a used capacity of a storage area of an archive system in a case where file is archived by a file size estimation method in accordance with the file process request to be described below.

Furthermore, the Quota value 303 of the file storage system 2 and the acquired NS Quota value (the estimated NS Quota value 313) of the archive system 3 may be a same value or may be different values.

FIG. 4 shows an example of the usage estimation table 400.

The usage estimation table 400 may be stored in a memory of each file server apparatus 10. The table 400 indicates, for each file operation in accordance with a process request of a file, a method of estimating a file size of an archive file when the file operation is performed. Hereinafter, file operations will be described.

File creation is a file operation based on a file creation request. In this operation, a file to be stored in the subtree is newly created.

File editing is a file operation based on a write request. In this operation, a file in a synchronized state is overwritten. In other words, when the replicated flag in the inode management table 600 is “ON”, a file stored in the subtree is updated.

File re-editing is a file operation based on a write request. In this operation, a file that is not in a synchronized state is overwritten. In other words, when the replicated flag in the inode management table 600 is “OFF”, a file stored in the subtree is updated.

File deletion is a file operation based on a file deletion request. In this operation, a file stored in the subtree is deleted.

Metadata operation is a file operation based on a metadata change request. In this operation, for example, metadata such as the owner or the access right in the inode management table 600 is directly edited.

Next, a method of estimating a file size of a file (a capacity estimation process) when a file operation is performed will be described. An estimation method of the estimated NS usage 315 is associated with each file operation. Examples of an estimation method for each file operation are as follows.

In the case of file creation (A1: first state), the estimated NS usage 315 after file creation is a value obtained by adding a size of an archive file of a target file to NS usage prior to file creation. The estimated NS usage 315 is the value adopted as the NS usage prior to file creation.

In the case of file editing (A2: second state), a value obtained by adding an amount of change of a size of an archive file of a target file after file editing to NS usage prior to file editing. Moreover, file editing is a file operation that is performed when a file that is an editing target is in a synchronized state.

In the case of file re-editing (A3: second state), a value obtained by adding an amount of change of a size of an archive file of a target file after file re-editing to NS usage prior to file re-editing. Moreover, file re-editing is not a file operation that is performed when a file that is an editing target is in a synchronized state. The estimated NS usage 315 is the value adopted as the NS usage prior to file re-editing.

In the case of file deletion (A4: third state), a value obtained by subtracting a size of an archive file of a target file from NS usage prior to file deletion. The estimated NS usage 315 is the value adopted as the NS usage prior to file deletion.

In the case of a metadata operation (A5: fourth state), a value obtained by adding an amount of change of a size of archive file management information due to a metadata operation to NS usage prior to the metadata operation. The estimated NS usage 315 is the value adopted as the NS usage prior to the metadata operation.

Moreover, in A1 to A4 described above, the file storage system 2 estimates a size of an archive file of a target file based on a size of the target file before writing the target file to a subtree. In this case, the file size of the target file is obtained by adding a size of a file portion that is a portion corresponding to the target file in file management information to a size of actual data of the target file. The file size of the archive file is obtained by adding a size of an archive file portion that is a portion corresponding to the archive file in archive file management information to a size of actual data of the archive file. The file storage system 2 estimates the size of the actual data of the archive file based on the size of the actual data of the target file and estimates the size of the archive file portion based on a size of the file portion.

For example, due to compression, deduplication, generation management, or the like performed accompanying replication or synchronization, the size of the actual data of a file may differ from the size of the actual data of an archive file. For example, the file storage system 2 estimates a value obtained by multiplying the size of the actual data of the file by a coefficient x set in advance as the size of the actual data of the archive file. The coefficient x is determined based on, for example, characteristics of data processing. Alternatively, the coefficient x may be determined based on, for example, a comparison between a size of actual data of an actual file and a size of actual data of an actual archive file. In addition, the file storage system 2 may store a size of actual data of an archive file every time a synchronization process is performed and estimate a size of actual data of the archive file after the synchronization process based on the stored size.

For example, the file storage system 2 estimates a value obtained by multiplying the size of a file portion by a coefficient β set in advance as the size of an archive file portion. A coefficient y is determined based on, for example, characteristics of a file system in the file storage system 2 and characteristics of a file system in the archive system 3. Alternatively, the coefficient y may be determined based on, for example, a comparison between a size of actual file management information and a size of actual archive file management information. In addition, the file storage system 2 may store a size of an archive file portion every time synchronization is performed and estimate a size of the archive file portion after synchronization based on the stored size.

FIG. 5 shows an example of linkage information 500.

The linkage information 500 indicates a linkage (correspondence) between a subtree of the file storage system 2 and an NS of the archive system 3. A subtree ID 501 is an identifier of the subtree. An NS path name 503 indicates a path to the NS corresponding to the subtree.

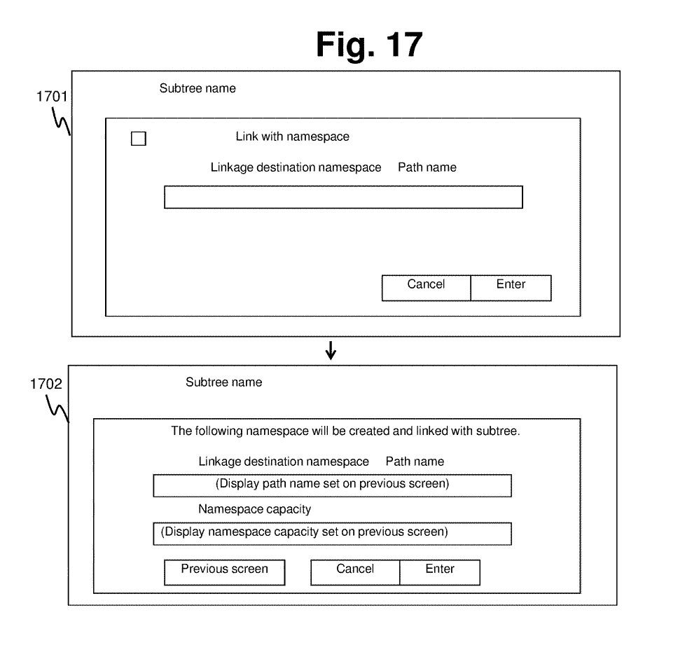

A linking process is process of associating a subtree of the file storage system 2 used by the host 12 to an NS of the archive system 3. The process is performed as the CPU 101 of the file server apparatus 10 executes a linkage program in the memory 100. The process is performed when there is an indication from the host 12 for an NS linking process with respect to a subtree used by the host 12. An indication of an NS linking process will be described with reference to FIG. 17. On an indication screen 1701 displayed on a display apparatus of the host 12, the user checks the fact that a subtree used by the user is to be linked with an NS, inputs a path name to the NS that is a linkage destination, and transmits an indication by pressing an “enter” button. Accordingly, a confirmation screen 1702 is displayed on the display apparatus. On the confirmation screen 1702, the user confirms the path name of the linkage destination NS and a usable restricted capacity (Quota value) of the linkage destination NS, and finalizes the indication by pressing the enter button. In the following description, a subtree and an NS to be targets of an indication of a linking process from the host 12 will be referred to as a target subtree and a target NS.

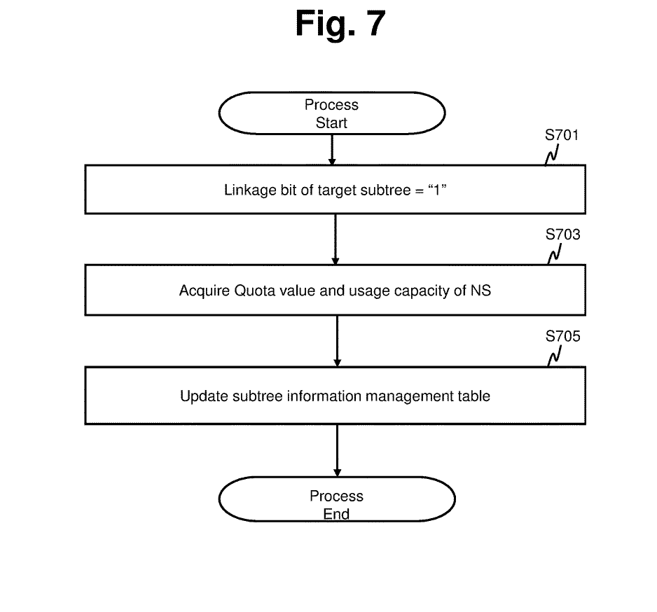

FIG. 7 shows a flow chart of a linking process.

In step S701, the linking process program associates the target subtree and the target NS with each other. Specifically, for example, the linking process program acquires the target NS from the archive system 3 and updates each table. Specifically, the linking process program sets the linkage bit of the target subtree in the subtree information management table 300 to “1” and, at the same time, registers a path to the target NS in the NS path name 503 of the target NS in the linkage information 500.

In step S703, the linking process program acquires the Quota value and usage of the target NS.

In step S705, the linking process program updates the subtree information management table 300. For example, the linking process program respectively registers the Quota value of the target NS in the acquired NS Quota value 309 and the estimated NS Quota value 313. In addition, for example, the linking process program respectively registers the usage of the target NS in the acquired NS usage 311 and the estimated NS usage 315.

According to the process described above, a subtree of the file system and an NS of the archive system can be associated with each other. In addition, a Quota value and usage of the NS corresponding to the subtree can be acquired from the archive apparatus. Moreover, as described earlier, the linking process program may respectively register a value set in advance by the user in the acquired NS Quota value 309 and the estimated NS Quota value 313 as the Quota value of the NS.

Next, a reception process performed by the reception program 110 will be described. The process is performed as the CPU 101 executes the reception program 110. This process may differ for each process request of a file. An orderly description will be given below.

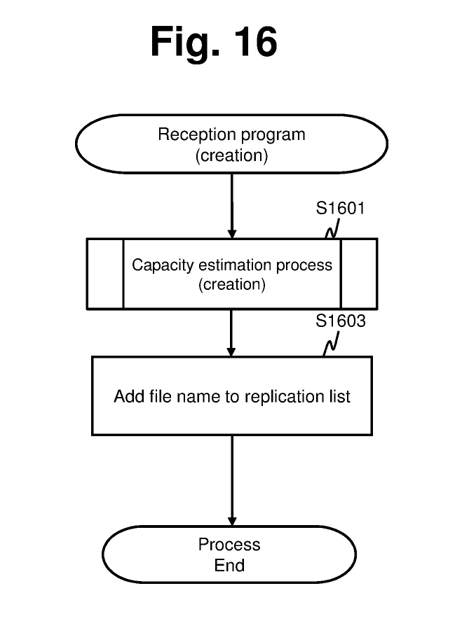

First, a case where the process request is a creation request of a file will be described. FIG. 16 shows a flow chart of a reception process of a creation request of a file.

In step S1601, when the reception program 110 receives a creation request as a process request of a file, the reception program 110 performs a capacity estimation process with respect to a target file. The capacity estimation process will be described later.

In step S1603, the reception program 110 registers a created file in a replication list and ends the process. In this case, a replication list refers to a list of created files to be targets of replication. After replication of the file is performed, the file is deleted from the replication list.

According to the process described above, when creating a file in a subdirectory of the file storage system 2, the file server apparatus 10 can estimate usage of an NS in a case where an archive file of a target file is created.

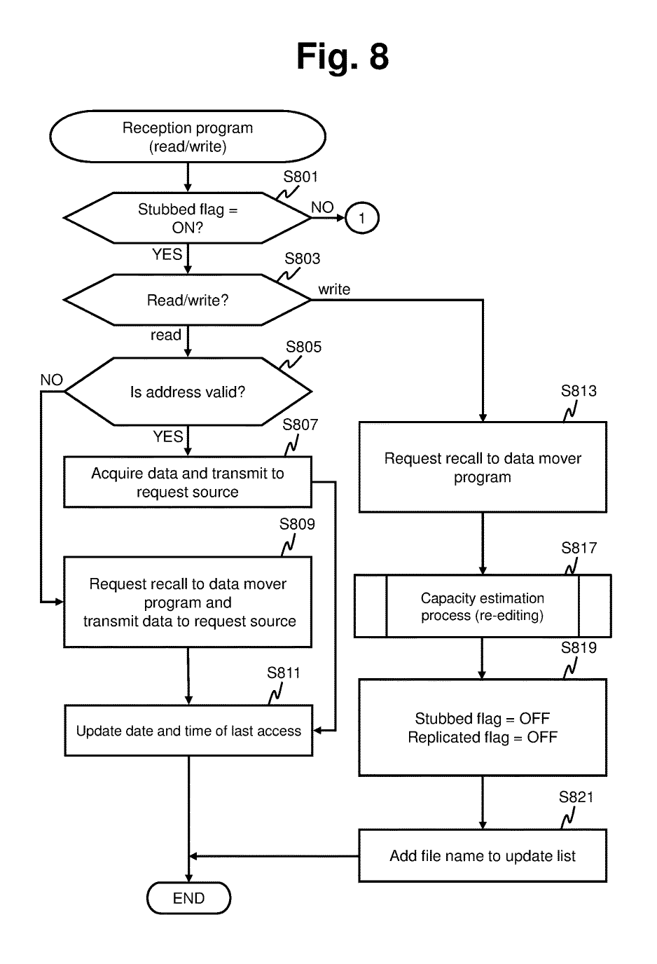

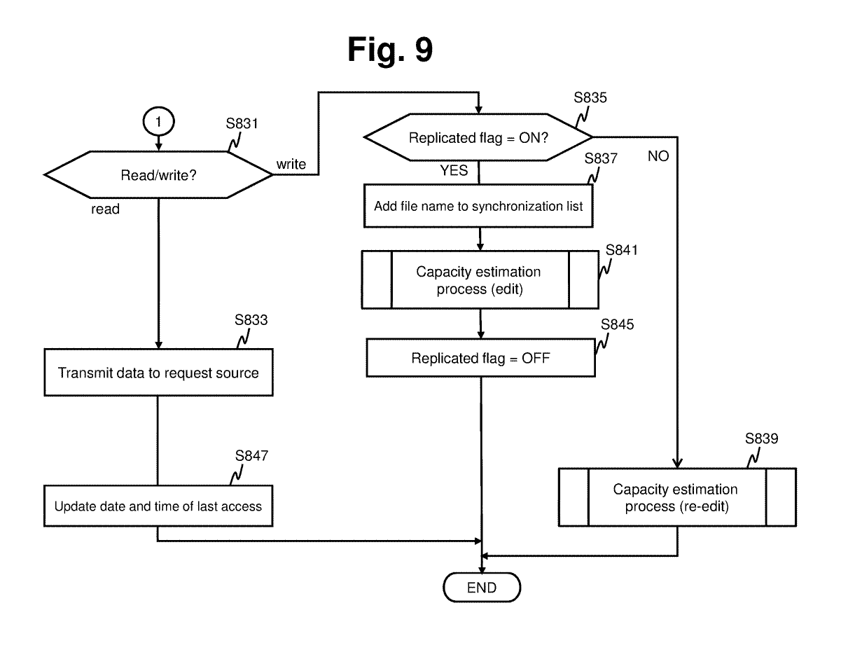

Next, a case where the process request is a read or write request will be described. FIG. 8 shows a first half of a flow chart of a reception process of a read or write request of a file. FIG. 9 shows a second half of a flow chart of a reception process of a read or write request of a file.

In step S801, when the reception program 110 receives a process request of a file, the reception program 110 identifies a file to be a target of the process request. In the description of this flow chart, this file will be referred to as a target file. Subsequently, the reception program refers to the inode management table 600 and checks a stubbed flag of the target file. When the stubbed flag is “ON” (Yes in S801), the reception program 110 advances the process to step S803. When the stubbed flag is “OFF” (No in S801), the reception program 110 advances the process to step S831 (to 1 in FIG. 9).

In step S803, the reception program 110 checks the received process request. When the process request is a read request (read in S803), the reception program 110 advances the process to step S805. When the process request is a write request (write in S803), the reception program 110 advances the process to step S813.

In step S805, the reception program 110 checks whether or not a block address in metadata of the target file is valid. When the block address is valid (Yes in S805), the reception program 110 reads the target file from the LU 114, transmits the read file to the request source (host 12), and advances the process to step S811.

On the other hand, when the block address is not valid (No in S805), the reception program 110 recalls the file. In other words, the reception program 110 issues an event of an acquisition request for acquiring a target file from the archive system 3 to the local mover 106, transmits a file acquired from the archive server apparatus 20 based on the request to the request source, and stores the target file in the LU 114.

In step S811, the reception program 110 updates the date and time of last access to the target file in the inode management table 600 and ends the process.

In step S813, the reception program 110 recalls a file or, in other words, issues an event of an acquisition request for a target file to the local mover 106 and acquires the target file from the archive system 3.

In step S817, the reception program 110 performs a capacity estimation process with respect to the target file. The capacity estimation process will be described later. Moreover, in this process, since a file in a synchronized state is to be overwritten, a re-editing operation of the file is to be performed.

In step S819, the reception program 110 turns off the stubbed flag and turns off the replication flag in the mode management table 600 with respect to the target file.

In step S821, the reception program 110 registers the target file acquired in S813 in a synchronization list and ends the process. In this case, a synchronization list refers to a list of updated files to be targets of a synchronization process. After a synchronization process of the file is performed, the file is deleted from the synchronization list.

Next, FIG. 9 will be described. In step S831, the reception program 110 checks the received process request. When the process request is a read request (read in S831), the reception program 110 reads the target file from the LU 114 and transmits the read file to the request source (host 12) (S833). Subsequently, in step S847, the reception program 110 updates the date and time of last access in the inode management table 600 with respect to the target file and ends the process.

On the other hand, when the process request is a write request (write in S831), in step S835, the reception program 110 checks the replicated flag of the target file. When the replicated flag is ON (Yes in S835), in step S837, the reception program 110 adds the target file to the synchronization list.

In step S841, the reception program 110 performs a capacity estimation process with respect to the target file. The capacity estimation process will be described later. Moreover, in this process, since a file in a synchronized state is to be overwritten, an editing operation of the file is to be performed.

In step S845, the reception program 110 turns off the replicated flag of the target file in the inode management table 600 and ends the process.

On the other hand, when the replicated flag is OFF (No in S835), in step S839, the reception program 110 performs a capacity estimation process and ends the process. Moreover, in this process, since a file that is not in a synchronized state is to be overwritten, a re-editing operation of the file is to be performed.

According to the process described above, when writing a target file to the file storage system 2, the file server apparatus 10 can estimate usage of an NS corresponding to a subtree in which the target file is stored in a case where an archive file of the target file is stored in the NS.

In this case, as described earlier, file management information and archive management information are different pieces of information and may have different sizes. Therefore, even when a same file is stored, respective used capacities may differ between a case where the file is stored in the file server apparatus 10 and a case where the file is stored in the archive server apparatus 20. In addition, as will be described later, methods of managing a file when the file is updated and the like differ between the file server apparatus 10 and the archive server apparatus 20. Therefore, by having the file server apparatus 10 estimate a used capacity in the archive server apparatus 20 based on a size of archive management information and a management method by the archive server apparatus 20 instead of calculating a used capacity in the file server apparatus 10, the used capacity of the archive server apparatus 20 can be discerned more accurately.

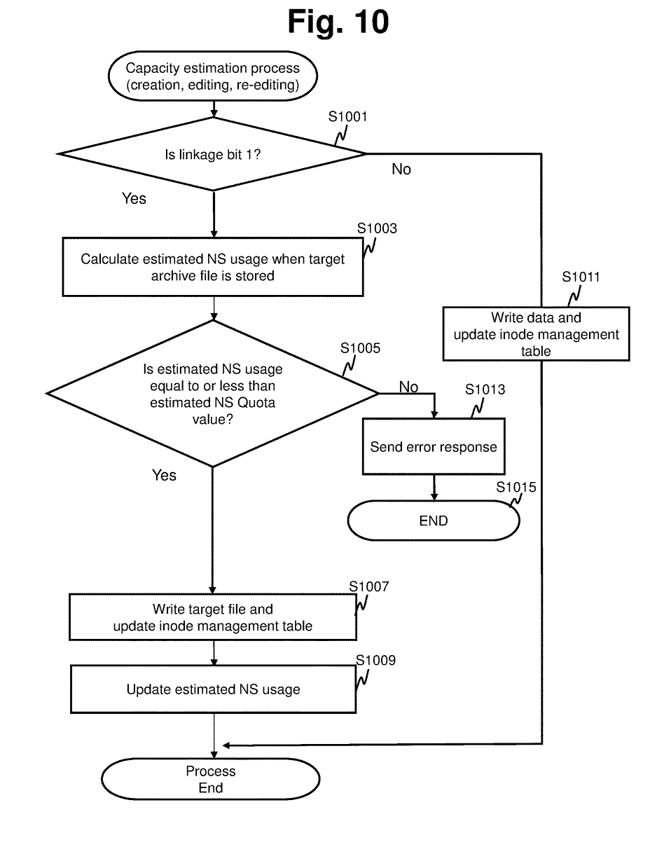

FIG. 10 shows a flow chart of a capacity estimation process when a creation request and a write request of a file are made. The capacity estimation process is performed within reception processes (S1601, S817, S841, and S839) when a creation request and a write request of a file are made.

In step S1001, the reception program 110 determines whether or not the linkage bit of a subtree in which a target file is stored in the subtree information management table 300 is “1”. When the linkage bit is “0” (No in S1001), in step S1011, the reception program 110 executes creation, editing, or re-editing of the target file, updates the inode management table 600, and ends the process. In the case of file creation, the reception program 110 adds an entry of the target file to the inode management table 600 and registers each item. In the case of file editing or file re-editing, for example, the reception program 110 updates the file size, the date and time of last access, and the like in the inode management table 600.

In step S1003, the reception program 110 estimates usage of an NS when assuming that a target archive file which is an archive file of the target file after the file operation is stored in the NS. In other words, the reception program 110 refers to A1, A2, or A3 in the usage estimation table 400 and calculates a value to be used as the estimated NS usage 315 in the subtree information management table 300.

In step S1005, the reception program 110 refers to the subtree information management table 300 and determines whether or not the estimated NS usage is equal to or smaller than the estimated NS Quota value 313. Since a determination that the estimated NS usage exceeds the estimated NS Quota value 313 (No in S1005) means that archiving cannot be performed, the reception program 110 transmits an error response to the host 12 and ends the process.

On the other hand, since a determination that the estimated NS usage is equal to or smaller than the NS Quota value (309 or 313) (Yes in S1005) means that archiving can be performed, the reception program 110 writes the target file to the LU 114 in accordance with the process request and updates the inode management table 600 (S1007). In the case of file creation, the reception program 110 adds an entry of the target file to the inode management table 600 and registers each item. In the case of file editing or file re-editing, for example, the reception program 110 updates the file size, the date and time of last access, and the like in the inode management table 600.

In step S1009, the reception program 110 updates the estimated NS usage 315 in the subtree information management table 300 with the estimated NS usage.

According to the process described above, the file server apparatus 10 can estimate usage of an NS when a target archive file is stored in the archive system 3 and determine whether or not the target archive file can be written to the NS. Accordingly, when the target archive file cannot be stored in the NS, an error response can be sent to a host without storing the target file in the file storage system 2.

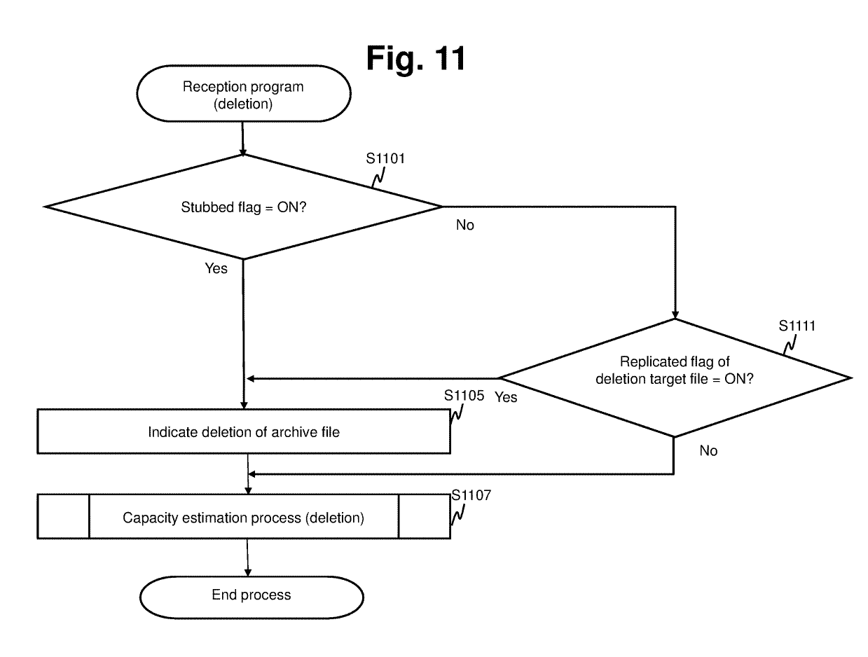

Next, a case where the process request is a deletion request of a file will be described. FIG. 11 shows a flow chart of a reception process of a deletion request of a file.

In step S1101, when the reception program 110 receives a deletion request as a process request of a file, the reception program 110 identifies a file to be a target of the process request. In the description of this flow chart, this file will be referred to as a target file. Subsequently, the reception program refers to the inode management table 600 and checks a stubbed flag of the target file. When the stubbed flag is “OFF” (No in S1101), the reception program 110 advances the process to step S1111. When the stubbed flag is “ON” (Yes in S1101), the reception program 110 advances the process to step S1105.

In step S1111, the reception program 110 determines whether or not the replicated flag of the target file in the inode management table 600 is ON. When the replication flag is ON (Yes in S1111), the reception program 110 advances the process to step S1105. When the replication flag is OFF (No in S1111), the reception program 110 advances the process to step S1107.

In step S1105, the reception program 110 issues an indication to delete an archive file of the target file to the archive server apparatus 20. Subsequently, the reception program. 110 performs a capacity estimation process accompanying the deletion operation of the file and ends the process. The capacity estimation process will be described later. Moreover, when a file is deleted in this process, a deletion operation of a file is performed. In addition, upon receiving the deletion indication of S1105, the archive server apparatus 20 may execute a deletion process of the archive file and respond to the reception program 110 with completion of the deletion process.

According to the process described above, when deleting a target file associated with a subdirectory of the file storage system 2, the file server apparatus 10 can estimate usage of an NS in a case where an archive file of the target file is deleted.

Moreover, while the reception program 110 issues a deletion indication of an archive file of a target file in S1105 described above, this is not restrictive. For example, the reception program 110 may add the archive file of the target file to a list as an archive file that is a candidate for deletion and transmit a deletion indication to the archive server apparatus 20 based on the list at a prescribed timing.

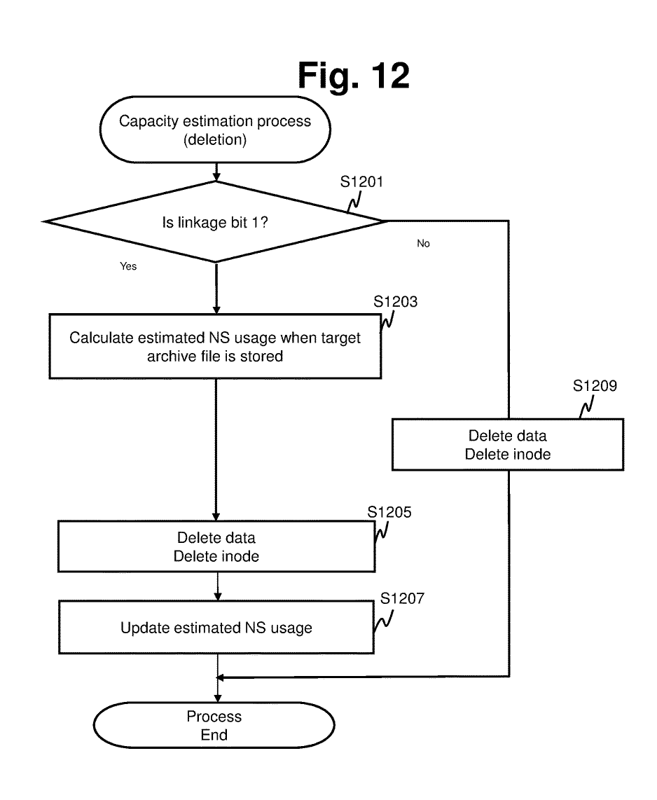

FIG. 12 shows a flow chart of a capacity estimation process when a deletion request of a file is made.

The capacity estimation process is performed within a reception process (S1107) when a deletion request of a file is made.

In step S1201, the reception program 110 determines whether or not the linkage bit of a subtree in which a target file is stored in the subtree information management table 300 is “1”. When the linkage bit is “0” (No in S1201), in step S1209, the reception program 110 deletes the target file stored in the LU 114, deletes an inode (entry) of the target file in the inode management table 600, and ends the process.

In step S1203, the reception program 110 estimates usage of an NS in a case where a target archive file which is an archive file of the target file is deleted. In other words, the reception program 110 refers to A4 in the usage estimation table 400 and calculates a value to be used as the estimated NS usage 315 in the subtree information management table 300.

In step S1205, the reception program 110 deletes the target file stored in the LU 114 and deletes an inode (entry) of the target file in the inode management table 600.

In step S1207, the reception program 110 updates the estimated NS usage 315 in the subtree information management table 300.

According to the process described above, the file server apparatus 10 can estimate usage of an NS when the target archive file is deleted from the archive system 3.

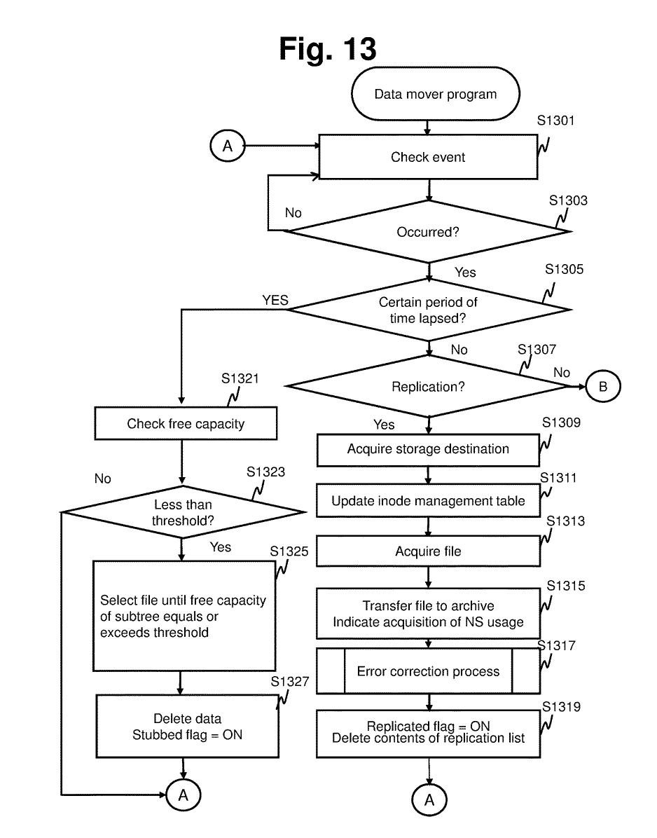

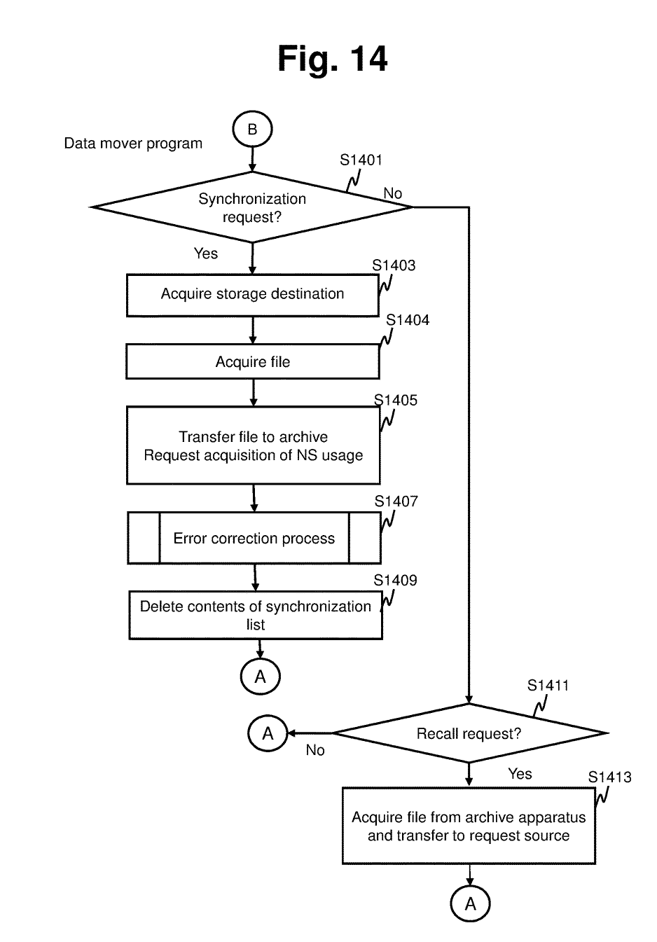

FIG. 13 shows a first half of a flow chart of a data mover process. FIG. 14 shows a second half of a flow chart of a data mover process. The data mover process is performed as the CPU 101 of the file server apparatus 10 executes the local mover 106 stored in the memory 120. This process is an event-driven process which is started up by an occurrence of an event. In addition, events of replication and synchronization are assumed to occur regularly or occur due to an indication from the host 12 and the like.

In step S1301, the local mover 106 checks which of a plurality of events configured in advance has occurred, and determines an occurrence of an event (S1303). When an event has not occurred (No in S1303), the local mover 106 returns the process to S1301. When an event has occurred (Yes in S1303), in S1305, the local mover 106 determines whether or not an event of a lapse of a certain period of time has occurred.

When an event notifying the lapse of a certain period of time has occurred (Yes in S1305), in step S1321, the local mover 106 checks a free capacity of each subtree stored in the file system. Moreover, a free capacity is a value obtained by subtracting the usage 305 from the Quota value 303.

When there is no subtree of which the free capacity is less than a threshold (No in S1323) (A in the drawing), the local mover 106 returns the process to S1301.

When there is a subtree of which the free capacity is less than the threshold (Yes in S1323), the local mover 106 selects a file stored in the subtree (subtrees) until the free capacity of the subtree (subtrees) becomes equal to or larger than the threshold.

In step S1327, the local mover 106 deletes data of the selected file from the LU 114, turns on the stubbed flag of the target file and deletes a value of the block address in the inode management table 600. Subsequently, the local mover 106 returns the process to S1301 (A in the drawing).

In step S1307, the local mover 106 determines whether or not the occurred event is a replication request. When the event is not a replication request (No in S1307) (B in the drawing), the local mover 106 advances the process to step S1401 (refer to FIG. 14).

When the event is a replication request (Yes in S1307), in step S1309, the local mover 106 acquires a storage destination of an archive file of a replication target file from the archive server apparatus 20.

In S1311, the local mover 106 sets a storage destination of an archive file to the link destination in the inode management table 600.

In S1313, the local mover 106 acquires a replication target file that is a file registered in a replication list from the LU 114. Specifically, for example, the local mover 106 transmits a read request of the replication target file to the reception program 110.

In S1315, the local mover 106 transfers the acquired replication target file to the archive server apparatus 20 and, subsequently, issues an indication to acquire usage of an NS after archiving the replication target file.

In S1317, the local mover 106 performs an error correction process. The error correction process will be described later.

In step S1319, the local mover 106 turns on the replicated flag of the replication target file in the inode management table 600, deletes contents of the replication list, and returns the process to step S1301 (A in the drawing).

Next, FIG. 14 will be described. In step S1401, the local mover 106 determines whether or not the event is a synchronization request of a file. When the event is not a synchronization request (No in S1401), the local mover 106 advances the process to step S1411.

When the event is a synchronization request (Yes in S1401), in step S1403, the local mover 106 acquires a storage destination of an archive file of a synchronization target file that is a file registered in the synchronization list from the inode management table 600.

In S1404, the local mover 106 acquires the synchronization target file from the LU 114. Subsequently, in S1405, the local mover 106 transfers the acquired synchronization target file to the archive server apparatus 20 and issues an indication to acquire usage of an NS after archiving the synchronization target file.

In S1407, the local mover 106 the local mover 106 performs an error correction process. The error correction process will be described later.

In step S1409, the local mover 106 deletes contents of the synchronization list and returns the process to S1301 (A in the drawing).

In step S1411, the local mover 106 determines whether or not the event is a recall request. When the event is not a recall request (No in S1411), the local mover 106 returns the process to S1301 (A in the drawing).

When the event is a recall request (Yes in S1411), in step S1413, the local mover 106 acquires data of an archive file of a recall target file from the archive server apparatus 20, transmits the data to the request source (the reception program 110), and ends the process.

According to the process described above, an error of the estimated NS usage 315 can be corrected with replication or synchronization of the target file.

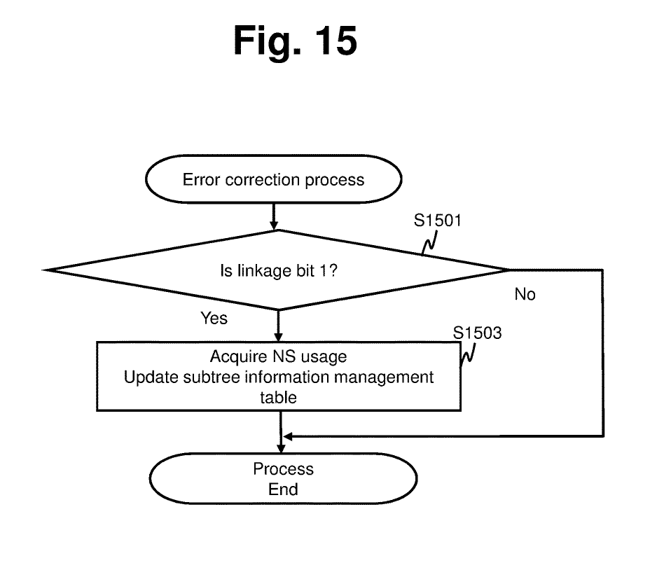

FIG. 15 is a flow chart of an error correction process.

The error correction process is the process of step S1317 or step S1407 in the data mover process.

In step S1501, the local mover 106 determines whether or not the linkage bit of a subtree in which a target file is stored in the subtree information management table 300 is “1”.

When the linkage bit is “0” (No in S1501), the local mover 106 ends the process. On the other hand, when the linkage bit is “1” (No in S1503), the local mover 106 updates the acquired NS usage 311 in the subtree information management table 300 based on the NS usage acquired in step S1315. In addition, the local mover 106 corrects the value of the estimated NS usage 315 based on the value of the acquired NS usage 311. Moreover, at this point, the local mover 106 may acquire the Quota value of the NS and update the acquired NS Quota value 309 and the estimated NS Quota value 313 in the subtree information management table 300.

According to the process described above, actual usage of an NS corresponding to a subtree in which the target file is stored can be acquired from the archive server apparatus 20. Accordingly, since the local mover 106 can correct an error of the estimated NS usage 315 in the subtree information management table 300, when next performing a file operation on a file to be stored in the subtree (in which the target file is stored), the local mover 106 can prevent an error of an estimated value of NS usage from increasing.

Moreover, while this process is performed as the process of step S1317 or step S1407 in the data mover process in the present embodiment, this is not restrictive. For example, the process may be performed when the file server apparatus 10 changes the Quota value of an NS or when an indication to acquire NS usage is received from the host 12.

Moreover, when the archive system 3 performs generation management, NS usage may include sizes of archive files including a plurality of generations or may only include a size of an archive file of a latest generation.

Moreover, while a capacity estimation process when a creation request, a write request, and a deletion request of a file are made has been described with reference to a flow chart in the present embodiment, this is not restrictive. For example, even when the metadata change request described earlier is made, a capacity estimation process may be performed when the linkage bit in the subtree information management table 300 is “0”. In this case, the file server apparatus 10 refers to A5 in the usage estimation table 400 and calculates (estimates) usage of an NS when archive file management information based on file management information (for example, the inode management table 600) is changed. Specifically, in addition, the file server apparatus 10 refers to the subtree information management table 300 and determines whether or not the estimated NS usage is equal to or smaller than the estimated NS Quota value 313. When the estimated NS usage exceeds the estimated NS Quota value 313, the file server apparatus 10 performs an error response to the host 12. On the other hand, when the estimated NS usage is equal to or smaller than the NS Quota value, the file server apparatus 10 updates the inode management table 600 and registers the NS usage in the estimated NS usage 315 in the subtree information management table 300.

According to the process described above, the file server apparatus 10 can estimate usage of an NS in a case where metadata of the archive system 3 is changed due to a change in metadata of the file storage system 2 and determine whether or not metadata can be changed. Accordingly, when the metadata of the archive system 3 cannot be changed, an error response can be performed to a host without changing the metadata of the file storage system 2.

While some examples have been described above, it should be obvious that the present invention is not limited to the described examples and that various modifications can be made without departing from the spirit and scope of the invention.

Moreover, the processor corresponds to the CPU 101 and the like, the storage apparatus corresponds to the RAID system 11 and the like; and the archive storage apparatus corresponds to the RAID system 21 and the like. In addition, archiving may be regarded as a concept including replication and synchronization. Furthermore, a capacity of a storage area of an archive system corresponds to the acquired NS Quota value 309, the estimated NS Quota value 313, or the like and a used capacity of the storage area of the archive system includes the acquired NS usage 311 and the estimated NS usage 315. In addition, a calculated used capacity corresponds to the estimated NS usage 315 and the like and an acquired used capacity corresponds to the acquired NS usage 311 and the like.

### REFERENCE SIGNS LIST

2 File storage system
3 Archive system
10 File server apparatus
107 File system
108 Subtree
206 Namespace

1. A file server apparatus coupled to a host computer, a storage apparatus configured to store data of a file, and an archive system in which a file stored in the storage apparatus is archived,
the file server apparatus comprising: a memory configured to store a program for controlling storage of data of a file in the storage apparatus; and a processor configured to execute the program,
the processor being configured to:
manage a capacity of a storage area of the archive system and a used capacity of the storage area;
when receiving a write request of a file from the host computer, calculate a used capacity of the storage area of the archive system in a case where a file related to the write request is archived;
determine whether or not the file related to the write request can be archived in the archive system based on the capacity of the storage area of the archive system and the calculated used capacity; and
when determining that archiving cannot be performed, notify the host computer of an error.

2. The file server apparatus according to claim 1, wherein the processor is configured to:
when determining that archiving can be performed, replace a value of the used capacity of the storage area with the calculated value of the used capacity; and
store data of the file related to the write request in the storage apparatus.

3. The file server apparatus according to claim 2, wherein the processor is configured to:
acquire a used capacity of the storage area of the archive system from the archive system at a prescribed timing; and
replace a value of the used capacity of the storage area with the value of the acquired used capacity.

4. The file server apparatus according to claim 3, wherein the prescribed timing is after transmitting data of a file stored in the storage apparatus to the archive system.

5. The file server apparatus according to claim 1, wherein the processor is configured to
calculate, using methods that differ depending on whether the write request is a creation request or an edit request of the file related to the write request, the used capacity of the storage area of the archive system in a case where the file related to the write request is archived.

6. The file server apparatus according to claim 1, wherein the file related to the write request includes actual data and management information,
when archived in the archive system, the file related to the write request is stored as an archive file including the actual data and archive management information, and
the processor is configured to,
when the write request is a creation request, calculate a used capacity of the storage area of the archive system in a case where the file related to the write request is archived, based on the used capacity of the storage area, a capacity of the actual data, and a capacity of the archive management information.

7. The file server apparatus according to claim 6, wherein the processor is configured to:
when the write request is an update request, calculate a differential capacity between a capacity before update and a capacity after update of the file related to the write request, and
calculate a used capacity of the storage area of the archive system in a case where the file related to the write request is archived, based on the used capacity of the storage area and the differential capacity.

8. The file server apparatus according to claim 1, wherein the capacity of the storage area of the archive system is a capacity configured for each user using the host computer.

9. A control method of file server apparatus coupled to a host computer, a storage apparatus storing data of a file, and an archive system in which a file stored in the storage apparatus is archived,
the file server apparatus including a memory which stores a program for controlling storage of data of a file in the storage apparatus and a processor which executes the program,
the control method comprising:
managing a capacity of a storage area of the archive system and a used capacity of the storage area;
when receiving a write request of a file from the host computer, calculating a used capacity of the storage area of the archive system in a case where a file related to the write request is archived;
determining whether or not the file related to the write request can be archived in the archive system based on the capacity of the storage area of the archive system and the calculated used capacity; and
when determining that archiving cannot be performed, notifying the host computer of an error.

10. A computer system, comprising:
a file server apparatus coupled to a host computer and configured to receive an access request to a file from the host computer;
a storage apparatus coupled to the file server apparatus and configured to store data of a file transmitted to the file server apparatus;
an archive server apparatus coupled to the file server apparatus and configured to receive an archive request for data of a file stored in the storage apparatus from the file server apparatus; and
an archive storage apparatus coupled to the archive server apparatus and configured to store data of a file transmitted to the archive server apparatus,
the file server apparatus being configured to:
manage a capacity of a storage area of the archive storage apparatus and a used capacity of the storage area;
when receiving a write request of a file from the host computer, calculate a used capacity of the storage area of the archive storage apparatus in a case where a file related to the write request is archived;
determine whether or not the file related to the write request can be archived in the archive server apparatus based on the capacity of the storage area of the archive storage apparatus and the calculated used capacity; and
when determining that archiving cannot be performed, notify the host computer of an error.
